(19) United States
(12) Patent Application Publication
(10) Pub. No.: US 2011/0140393 A1
(43) Pub. Date: Jun. 16, 2011

(54) Height adjustable articulated tow hitch

(76) Inventors: Randy M. Padilla, Albuquerque, NM (US); Abel S. Esquibel, Albuquerque, NM (US)

(21) Appl. No.: 12/928,439

(22) Filed: Dec. 10, 2010

Related U.S. Application Data
(60) Provisional application No. 61/284,165, filed on Dec. 14, 2009.

(51) Int. Cl. B60D 1/46

(52) U.S. Cl. 280/490.1

(57) ABSTRACT

A height adjustable, articulating tow hitch assembly for connecting a towing vehicle to a towable vehicle, comprising in one embodiment an upper housing, a lower housing connected to the upper housing, the lower housing further comprising a hollow port formed therethrough adapted to receive and securely retain an elongated, variable height tongue member, the hollow port further being adapted to allow the tongue member to articulate or laterally move over a predetermined angular range as predetermined. A stop mechanism (such as a bolt mechanism) is formed on the tongue member's near end, the stop mechanism adapted to prevent the tongue member from being removed from the lower housing's hollow port while allowing longitudinal extension and retraction of the tongue member within the lower housing, and further, allowing angular movement of the tongue member when the tongue is in an extended position away from the upper housing.

### CLAIM OF PRIORITY

The present invention claims the benefit and priority of U.S. Provisional Patent Application No. 61/284,165 filed on Dec. 14, 2009, titled “Articulated Tow Hitch”.

### FIELD OF INVENTION

The present invention is generally directed towards an articulated tow hitch for a vehicle which is adapted to mechanically couple a vehicle to a towable trailer or like device's towing assembly.

### BACKGROUND OF THE INVENTION

It is well known that a vehicle has the ability to tow a trailer or like device for transporting additional objects (such as, for example, animals, furniture, environmental waste, vehicles, travel trailers, utility trailers, sports trailers, cargo trailers, motorcycle trailers, tow dollies, auto transports, or other objects or items which may not be conveniently placed within the towing vehicle). In such situations, a typical connection is made between the towing vehicle's (e.g., car, truck, military transport, SUV, etc.) receiver and the towed trailer though a fixed position mechanical assembly connection. Most typically, the fixed position mechanical assembly connection is made through a ball (located on the vehicle's receiver) and hitch (located on the trailer) assembly, which when coupled, allows for relative movement between the vehicle and the trailer. A conventional receiver used on or securely attached to vehicles is usually described as a short, elongated, square metal bracket having a aperture formed through the length of the bracket which is adapted to receive a hitch assembly.

Numerous prior art technologies discuss various connections and connection options, whether by ball and hitch assembly or otherwise. Thus, for example, such prior art discussions include U.S. Pat. Nos. 3,622,182, 4,515,387, 5,277,447, 5,011,176, 5,322,315, 5,580,088, 5,769,443, 5,941,550, 6,286,853, 6,357,779, 6,328,326, 6,502,845, 6,802,523, 6,820,888, 6,962,361, 6,974,146 and 7,125,033. Other representative disclosures include U.S. Patent Publication Nos. 2002/0089147, and 2006/0267310.

However, the ability to easily connect or couple the vehicle and the trailer is generally difficult because it requires a driver to manually align or otherwise register the towing assemblies (e.g., ball and hitch) for coupling. When this manual alignment does not occur, the driver is then forced to re-try to couple the connection by adjusting the position of the vehicle, adjusting the position of the trailer or both, and oftentimes, this feat is attempted numerous times before final coupling is achieved.

There are additional problems known in the trailer hitch industry when it comes to coupling a trailer or light vehicle to an automobile. For example, the connection point for the mechanical connection is generally not visible from the driver's seat of the vehicle, therefore making it difficult for the driver to easily make the desired aligned coupling connection on the first couple of attempts. As another example, an alignment problem typically arises when the driver attempts to couple the connection because the convergent point between the towing assemblies is out of the driver's view. Additionally, damage may occur to the vehicle's bumper or other body parts while attempting to couple the towing assemblies if the towing assemblies are misaligned, as the vehicle will likely collide with the trailer's towing assembly. Another problem exists when a driver attempts to maneuver a vehicle in reverse travel to a specific point or connection of the trailer. In these situations, it may be common to use another person, or a “spotter”, to help direct the driver to the connection point. Even if a spotter attempts to assist the driver to couple the towing assemblies, this process is one of trial and error, involving numerous attempts before the connection between the vehicle in the trailer is made. Moreover, in many instances, a spotter may not be available to help the driver make the towing assembly connection. In these cases, it is extremely difficult to make a connection unless multiple attempts are attempted to make the connection.

Driving a vehicle in reverse direction in order to couple the towing assemblies is further counter intuitive compared to driving a vehicle in the forward direction. Thus, for example, while traveling in the forward direction, the vehicle will turn in the direction of the steering wheel, yet conversely, the vehicle will turn in the opposite direction while in the reverse direction. Another significant problem exists when the vehicle connection point is that at different heights or different elevation in comparison to the device being attached. Another significant problem arises when the load on the trailer is significant, thereby preventing the driver (and the driver's spotters) from easily placing the trailer's towing assembly to the vehicle's towing assembly, and significantly raising the possibility of physical injury.

Finally, a problem exists with many connection technologies, as they require a number of mechanical steps before a trailer may be safely towed. Also, many systems or devices require the use of specialized or external tools, which may or may not be readily at hand or nearby, which compounds the overall problems associated with making a connection.

The present invention provides an elegant solution for many of these problems, without mechanical complexity. Thus, for example, the height adjustable features, the lateral extension features and/or the articulating features of the present invention allows for a final connection to be made from outside the vehicle by a single person, thereby avoiding the mistakes that may occur from operating the vehicle or requiring additional help for directional control. Additionally, because of the pivoting, articulating and orbital nature of the invention, differences in height, elevation or even the load found on the trailer are compensated for ease of coupling. Moreover, the integrated nature of the present invention does not require the use of specialized tools or connections, thereby making the present invention useful in a number of situations.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

The present invention is generally defined as an articulated tow hitch for a vehicle which is adapted to mechanically couple a vehicle to a towable trailer or like device's towing hitch assembly. In general, a height adjustable articulated tow hitch for connecting a towing vehicle to a towable vehicle is disclosed, where the towed vehicle has a towing hitch attachment. The present invention includes an upper housing adapted to be attached to a receiver port on the towing vehicle via a conventional attachment means (such as, for example, a pin and cotter assembly), a lower housing connected to the upper housing, the lower housing further comprising a hollow port formed therethrough adapted to receive and securely retain an elongated, variable height tongue member, the hollow port further being adapted to allow the tongue member to extend, articulate or laterally move over a predetermined longitudinal or angular range as predetermined. A typical receiver structure will be of the type that receives the elongated square top housing and typically carrying a ball hitch assembly.

Preferably, the lower housing has a near end and a far end, with the hole forming the port on the far end being dimensionally larger than the hole forming the port on the near end. In one embodiment, the tongue member has a near side and a far side, with the far side adapted to receive and securely retain the ball hitch assembly or like hitching device. The tongue member, when retained within the lower housing's hollow port, is also adapted to be substantially extendable within the lower housing's hollow port in a direction approximately longitudinal, yet laterally angular, to the length of the upper housing to allow connection of the present invention to a towable vehicle. The tongue member further has a plurality of holes formed therethrough along the length of the tongue member to accommodate various extension lengths as desired. The longitudinal extension and angular range of the tongue member from the lower housing is preferably controlled by a spring-loaded release and lock pin means extending through the upper housing, the lower housing, and through a predetermined hole in the tongue member. A stop mechanism (such as a nut and bolt mechanism) is formed on the tongue member's near end, the stop mechanism adapted to prevent the tongue member from being removed from the lower housing's hollow port while allowing longitudinal extension and retraction of the tongue member within the lower housing, and further, allowing angular movement of the tongue member when the tongue is in an extended position away from the upper housing. In this regard, use of the present invention does not require the towing vehicle to align directly with the towed vehicle for hitch connection.

This disclosure describes numerous specific details that include specific structures and elements, their particular arrangement, and their particular functions in order to provide a thorough understanding of the present invention. One skilled in the art will appreciate that one may practice the present invention without the specific details.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

FIG. 1 is a side perspective view of one embodiment of the present invention, illustrating the tongue member in an articulated position and with a higher elevational position;

FIG. 2 is a top plan view of the illustration shown in FIG. 1;

FIG. 3 is a bottom plan view of the illustration shown in FIG. 1;

FIG. 4 is a front side plan view of the illustration shown in FIG. 1;

FIG. 5 is a rear side plan view of the illustration shown in FIG. 1;

FIG. 6 is a right side plan view of the illustration shown in FIG. 1;

FIG. 7 is a left side plan view of the illustration shown in FIG. 1;

FIG. 8 illustrates a left side plan view of another embodiment of the present invention, having the tongue member in a lower elevational position;

FIG. 9 illustrates a left side plan view of another embodiment of the present invention, having the tongue member in a substantially or approximately flat elevational position;

FIG. 10 is a top side plan view of the present invention with the tongue member in an extended (engaged) longitudinal position;

FIG. 11 is a top side plan view of the present invention with the tongue member in an extended (engaged) longitudinal, articulated first position;

FIG. 12 is a top side plan view of the present invention with the tongue member in an extended (engaged) longitudinal, articulated second position;

FIG. 13 is a close up view of the spring-loaded release and lock pin mechanism engaging a hole formed in the tongue member;

FIG. 14 is a close up view of the spring-loaded release and lock pin mechanism disengaging any holes in the tongue member;

FIG. 15 illustrates another embodiment of the present invention as may be needed for attachment with trailers having various anti-sway bar hitch systems; and

FIG. 16 is another embodiment of the present invention as may be needed for attachment with trailers having various weight distribution hitch systems.

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

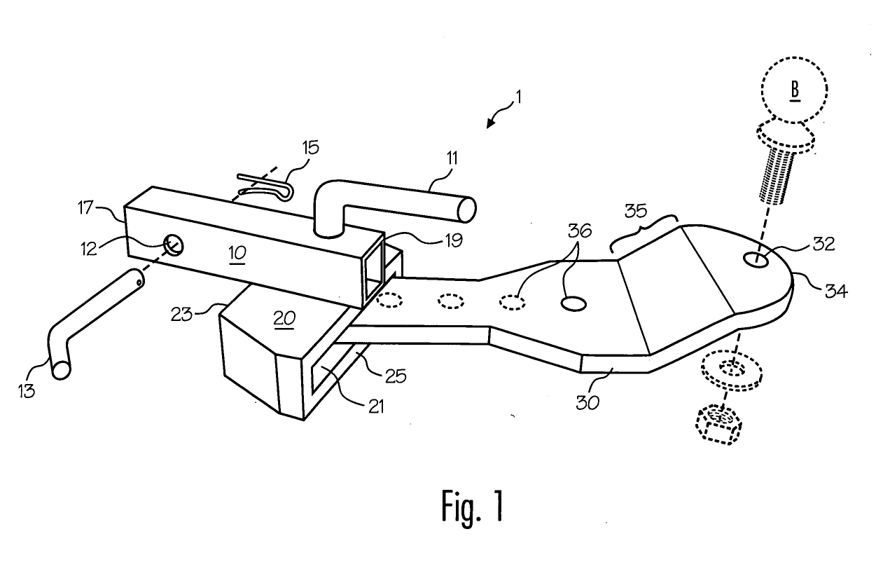

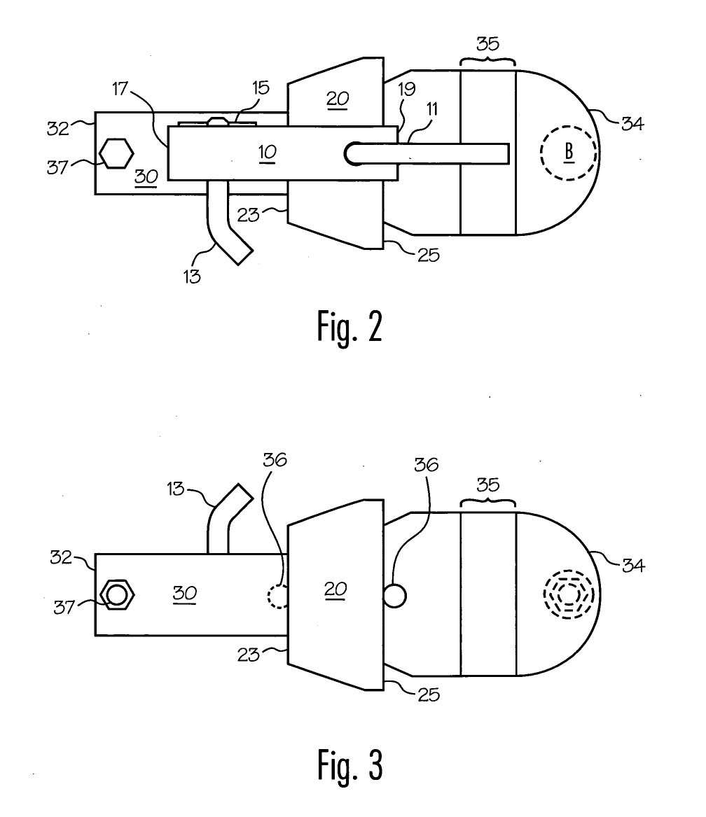

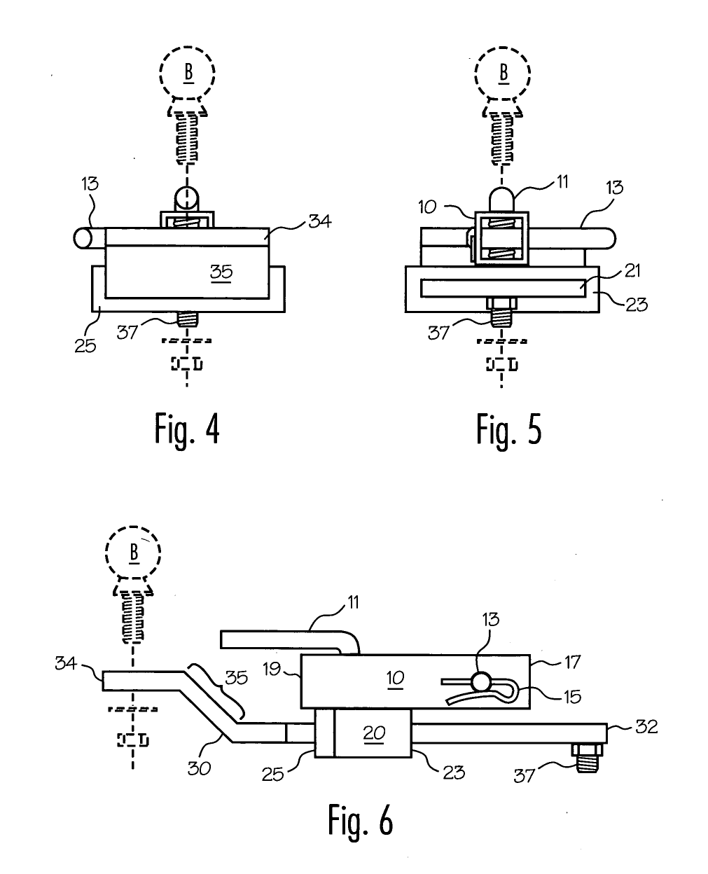

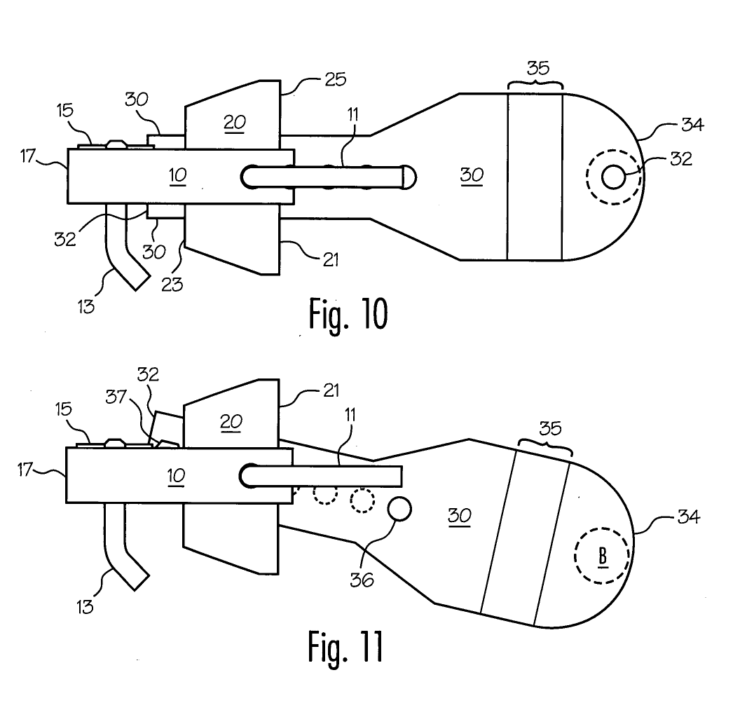

The present invention is a height adjustable articulated tow for connecting a towing vehicle to a towable vehicle. One embodiment of the present towing hitch assembly is the towing assembly 10 shown in FIGS. 1-14. As illustrated, assembly 1 includes three primary components, comprising an upper housing unit 10, a lower housing unit 20, and an elongated tongue member 30.

Upper housing unit 10 is generally described as an elongated square structure having a near end 17 (nearest to the receiver) and a distal end 19 (at the end furthest from the receiver). The upper housing unit is preferably a square tube so that it has an aperture formed through the length of the upper housing unit 10. The upper housing unit 10 is adapted to be attached by a locking means to a conventional receiver (or, receiver port) which is already attached to a towing vehicle (not shown, but known to those in the art). The upper housing unit 10 further may be defined to have an opening 12 formed perpendicular to the length of the upper housing unit 10, the opening 12 adapted to receive and retain a conventional locking pin assembly (13, 15) or like coupling means. The locking pin assembly 13, 15 is adapted to mechanically couple and secure the assembly 1 to a receiver attached to a towing vehicle. When the locking pin assembly 13, 15 is removed from the upper housing unit 10, the assembly 1 may then be removed from the receiver. While the locking pin assembly depicted in the drawings illustrate locking rod 13 and cotter pin 15, those of skill in the art will recognize that other locking means could be used to attach the upper housing 10 to a receiver (such as, for example, a locking rod and locking key assembly, which might be useful for those situations where the present invention must remain coupled to the receiver, or where removal of the assembly 1 from a receiver is not desired).

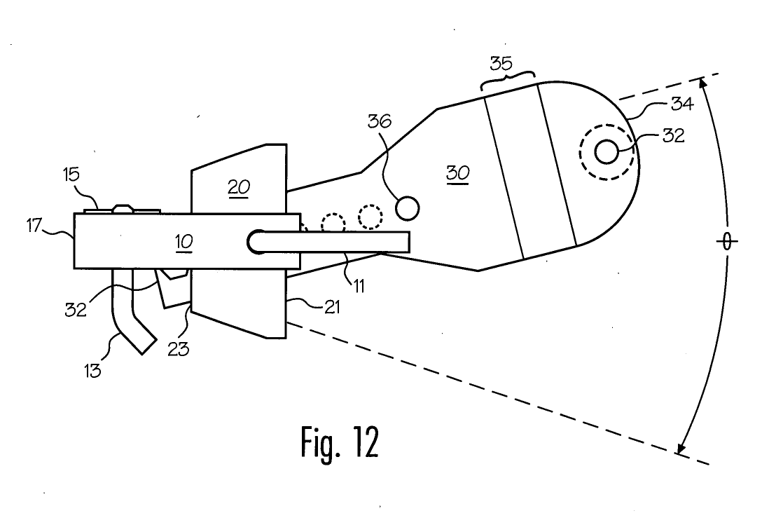

Lower housing unit 20 is coupled to (or may be formed integral with, as to form a single housing unit) upper housing unit 10 at approximately the upper housing unit's distal end 19. Lower housing unit 20 may be described as a hollow, generally rectangular structure varying in width from the near end of the rectangle 23 (at the end nearest to the receiver) to the distal end of the rectangle 25 (at the end furthest from the receiver). Because of this variation in width, the rectangular hollow portion 21 of the unit 20 may be described to be similar to a hollow portion within a cone structure, having a generally tapered interior wall structure between a single pair of opposite interior walls from the distal end 25 of the rectangle and the near end 23 of the rectangle (where the other pair of opposite interior walls are not tapered). The horizontal width of the hollow portion 21 at the distal end 25 of the rectangle defines the predetermined horizontal articulation angle Theta (“Θ” as seen in FIG. 12) achievable by the present invention, which is predefined and set by the manufacturer in accordance with industry regulations.

Tongue member 30 is an elongated plate structure which is adapted to be slideably extendable, slideably retractable and slideably articulated within the lower housing's hollow portion 21. Tongue member 30 has a near tongue portion 32 (at the portion nearest to the receiver), a far tongue portion 34 (at the portion furthest from the receiver), and a middle tongue portion 35 (at a portion generally between the near tongue portion 32 and the far tongue portion 34). The near tongue portion 32 has a hole 39 formed therethrough which is adapted to receive the stem of a retaining bolt mechanism 37. Preferably, the retaining bolt mechanism includes a countersink bolt and securing nut (or, countersink assembly), so that the head of the bolt does not protrude above the surface of the near tongue portion 32 when secured by the nut. The tongue member's far tongue portion 34 has a hole 33 formed therethrough at a generally center location, the hole 33 preferably being sized to receive a stem from a ball hitch assembly B as shown in the attached drawings. When the stem of the ball hitch assembly B is inserted into the hole 33, a securing nut will securely attach the ball hitch assembly to the tongue member 30. Optionally, far tongue portion 34 may also include visual means (such as, for example, reflective paint or tape) which, when illuminated, allows a person to visually identify that the far tongue portion 34 is extending away from the towing vehicle and may present a danger if the person is too close to the far tongue portion.

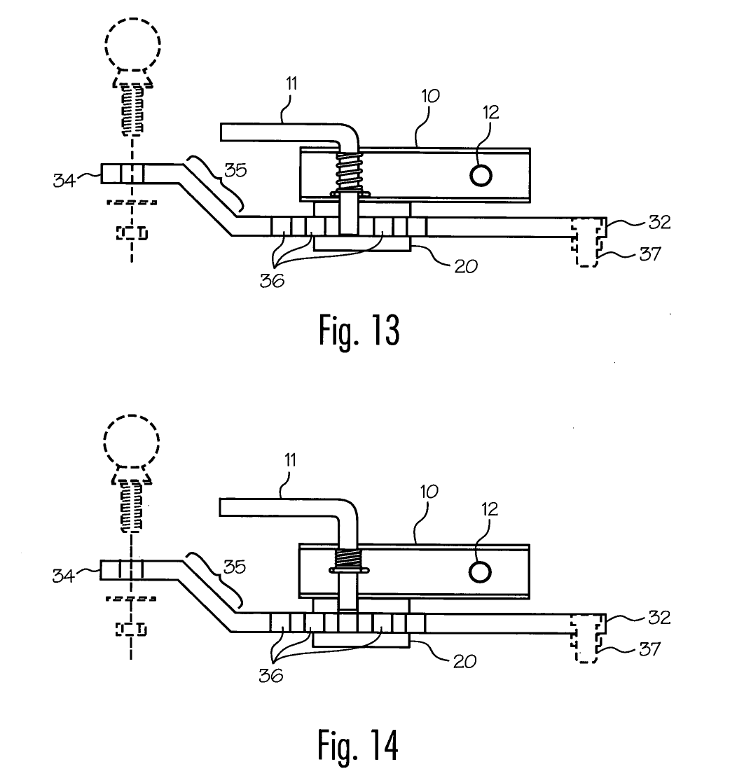

Tongue member 30 also preferably has one or more tongue holes 36 formed therethrough down a longitudinal center path. The longitudinal extension and angular range of the tongue member 30 from the lower housing 20 is preferably controlled by a spring-loaded release and lock pin mechanism 11 extending through the upper housing, the lower housing, and through a predetermined hole in the tongue member. Thus, for example, the release and lock pin mechanism 11 is shown engaging a hole 36 in FIG. 13, which means that the assembly 1 is in a locked (or, engaged, biased or unreleased) position, preventing any extension or retraction of the tongue member 30. Alternatively, as shown in FIG. 14, the release and lock pin mechanism 11 is shown not engaging any hole 36 which means that the assembly 1 is in an unlocked (or, disengaged, unbiased or released) position allowing extension or retraction of the tongue member 30. In this regard, mechanism 11 may be said to be engagable with any hole 36 on tongue member 30 to achieve a locked or unlocked position. Optionally, the release and lock pin mechanism 11 may communicate with a visual control electronics (not shown) indicative of when the lock pin 11 is engaging any of holes 36, or when the lock pin 11 is not in an engaged position. Optionally, the visual control electronics may either be formed on the assembly 1 itself, or, it may be attached to the interior of the towing vehicle. A stop mechanism 37 (such as a bolt mechanism) is formed on the tongue member's near end, the stop mechanism 37 adapted to prevent the tongue member 30 from being removed from the lower housing's hollow port 21 while allowing longitudinal extension and retraction of the tongue member 30 within the lower housing, and further, allowing angular movement of the tongue member 30 when the tongue 30 is in an extended position away from the upper housing 10.

Each tongue hole 36 is adapted to securely receive the locking rod 11, so that the tongue member 30 may be extended to a predetermined longitudinal locking length. If the locking rod 11 does not engage any hole 36 or, is disengaged from any hole 36 as illustrated in FIGS. 13 and 14, the tongue member 30 may then be articulated to any desired lateral angular position within the predetermined horizontal articultion angle Theta Θ.

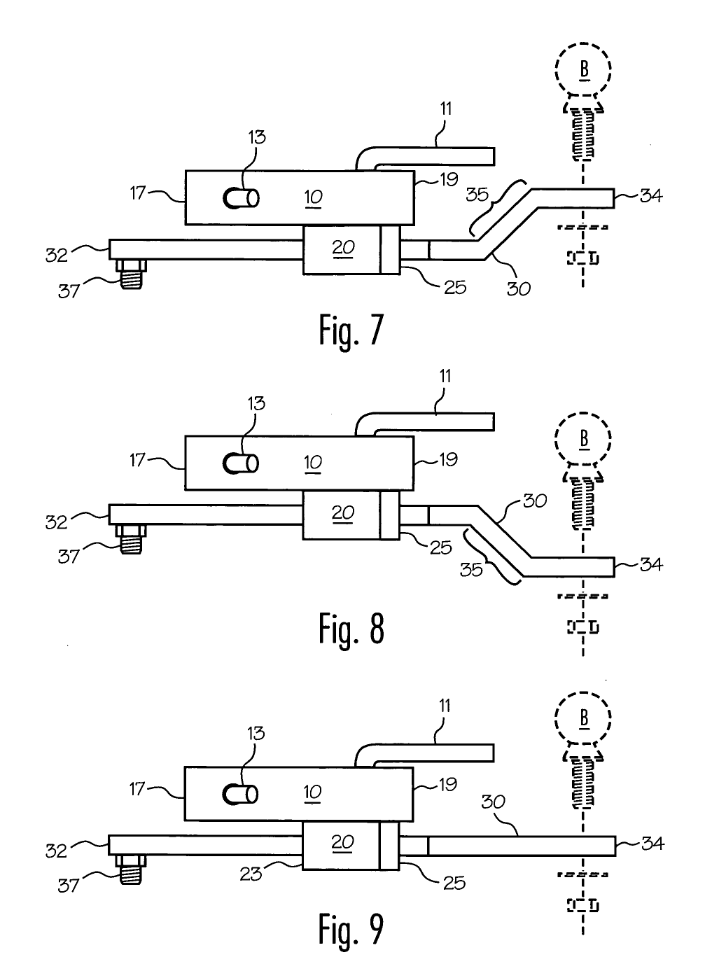

Another novel aspect of the present invention is the invention's ability to couple with a towed trailer which may be at a different elevation or height than the assembly 1. In this regard, tongue member 30 further includes a middle tongue portion 35 which is adapted to provide a height differential adjustment between the near tongue portion 32 relative to the far tongue portion 34. Thus, for example as seen in FIGS. 1 and 4-7, middle tongue portion 35 is adapted to create an increased height differential from the near tongue portion 32 relative to the far tongue portion 34. This embodiment would be used, for example, where the towed trailer hitch assembly is positioned at an elevation higher than assembly 1. In another embodiment as seen in FIG. 8, middle tongue portion 35 is adapted to create a decreased height differential from the near tongue portion 32 relative to the far tongue portion 34. This embodiment would be used, for example, where the towed trailer hitch assembly is positioned at an elevation lower than assembly 1. Those of skill in the art will recognize that there is no structural formation difference between the tongue member embodiments shown in FIGS. 7 and 8, because the tongue member in FIG. 7 is merely turned over (or, rotated one hundred and eighty degrees) for the illustration shown in FIG. 8 (of course, with the ball hitch assembly B and bolt mechanism 37 also being appropriately placed). And in still another embodiment as shown in FIG. 9, middle tongue portion 35 is adapted to create an approximately equal (or, flat) height differential from the near tongue portion 32 relative to the far tongue portion 34. This embodiment would be used, for example, where the towed trailer hitch assembly is positioned substantially the same elevation as assembly 1. If needed, one or more gusset structures (not shown) may be coupled to the middle tongue portion 35 to provide additional structural strength.

When the tongue member 30 slideably engages within hollow portion 21, it must first be secured to the overall assembly 10 once the ball hitch assembly B and the retaining bolt mechanism 37 are securely coupled to the member 30. In this position, the tongue member 30 is not only slideably extendable within hollow portion 21, it may also be slideably and laterally articulated within the lower housing's hollow portion 21.

In operation, a towing vehicle will be positioned to be relatively adjacent to, or close to, the towed vehicle's hitch assembly. The exact position between the vehicle's receiver and the towed vehicle's hitch assembly does not have be exact, so that perfect alignment is not required. When the upper housing unit 10 is securely attached to a receiver, locking pin mechanism 11 is disengaged from any hole 36 to allow the tongue member 30 to be extended away from the receiver (or, telescopically slide away from the receiver) in a longitudinal direction to a predetermined length. When the locking rod 11 disengages any hole 36, the tongue member 30 is then allowed to swivel or rotate to any lateral position within the path of predetermined horizontal articulation angle Theta (angle “Θ” in FIG. 12), which should be within reach of the towed vehicle's hitch assembly for connection. After connection is made, the towed vehicle may then move in a forward direction, in which case the towed vehicle's resistance will be such that it forces the lock mechanism 11 to engage any of holes 36, and allow the towed vehicle to be pulled in an aligned direction. When not in use, preferably, tongue member 30 is moved to retract into lower housing 20 longitudinally, with mechanism 11 engaging a hole 36 to keep the member 30 from further movement. Moreover, when not in use, assembly 1 may easily be removed from a receiver. The ability for the present invention to extend both longitudinally and laterally from the towing vehicle towards the towed vehicle results in an easier connection method.

While many of the components described herein include square shaped structures, those of skill in the art will recognize that other geometrically shaped structures may also be used (e.g., multi-angled members, tubular members, etc.) and remain within the scope of the present invention. Additionally, while individual components are disclosed, those of skill in the art will recognize that certain components may be made as an integral structure (for example, the upper housing unit may be integrally formed with the lower housing unit). Moreover, those of skill in the art will recognize that the materials forming the present invention are preferably made from high strength steel, steel composite or any like strengthened material(s) typically found in the towing industry.

In some instances, the use of a trailer's stabilizing system (or, anti-sway bars) are required. Towing a travel trailer may be a hazardous endeavor, because there is a tendency of a trailer to sway. A trailer is typically hitched about 4 feet behind the towing vehicle, which gives the trailer enough leverage to affect the movement of the towing vehicle, causing a back-and-forth movement that is known as sway, or fishtailing. A well-balanced trailer, with a proper anti-sway hitch correctly installed, will easily correct itself in the event of a minor sway caused by wind or other external factors. The use of a sway bar will also improve the ability of a trailer to resume normal towing alignment after a minor sway.

Trailer sway bars are usually installed on the trailer by dealers and are relatively inexpensive. Sway bars come in pairs and rely on brake pads to supply the friction that helps to control the swaying effect of the trailer. They have tension controls that are tightened manually and must be adjusted to reflect road conditions. Over-tightening will result in the trailer having a reduced ability to follow easily through turns. Under-tightening will prevent the sway bar from functioning efficiently and will not reduce sway adequately. Correct installation and adjustment of a sway bar will reduce the tendency of a trailer to sway. Proper installation of the trailer hitch, correct balancing of the load in the trailer and avoidance of abrupt steering maneuvers will assist the sway bar in maintaining the equilibrium of a trailer and tow vehicle.

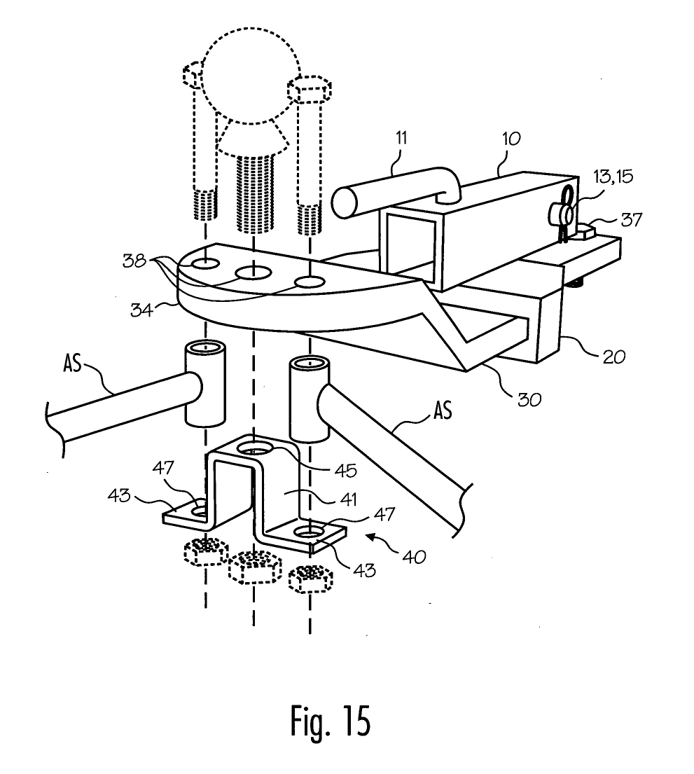

Thus, in another embodiment of the present invention as seen in FIG. 15, the present invention may be modified for use with a trailer's anti-sway system (generally indicated in FIG. 15 as “AS”) having one or more tubular attachment support means. In this embodiment, far tongue portion 34 has formed a plurality of holes 38 therethrough, with the center hole adapted for receiving the ball hitch B stem. An anti-sway attachment means 40 is disclosed for use in this embodiment, the means 40 comprising a generally upside-down “U” shaped attachment, having opposite legs 43 integrally formed with U-shaped member 41. Both legs 43 have a leg hole 47 formed therethrough, while U-shaped member 41 has a member hole 45 formed therethrough at a generally middle section. Leg holes 47 are formed to vertically register with any of holes 38, while member hole 45 is formed to vertically register with hole 38 containing the ball hitch B stem. In this regard, the tubular attachment support means from an anti-sway system AS are placed in registry with holes 38 and 47, and an exemplary bolt and nut system is placed through hole 38, through the tubular attachment means and then though holes 47, and coupled to a nut for secure attachment between assembly 1 and an anti-sway system AS. The operation of this embodiment is similar to the operation described above.

Alternatively, when towing a trailer with a standard ball hitch assembly, all of the trailer's tongue weight is transferred to the tow vehicle. Since the trailer hitch is attached to the vehicle frame via a receiver, the additional weight in the rear portion of the towing vehicle will lower the back end of the vehicle while raising the front end. This means that the towing vehicle's rear axle will be handling not only the trailer tongue weight but the additional load of the weight being transferred from the front axle. Less weight on the vehicle's front axle can cause diminished driving performance, decreases in steering control, traction and stopping and simultaneously increase trailer sway. Weight distribution hitch assemblies add spring bars to the hitch system that apply leverage between the towing vehicle and the towed trailer. This leverage transfers the load sitting on the rear of the towing vehicle to all the axles of the vehicle and trailer. With the trailer tongue and rear cargo load distributed between the axles, the vehicle is leveled off and performance is greatly improved. Weight distributing systems should be used any time the trailer weighs more than 50 percent of the vehicle's weight. A weight distributing hitch assembly is designed to obtain the maximum rated towing capacity, while still providing a safe driving experience.

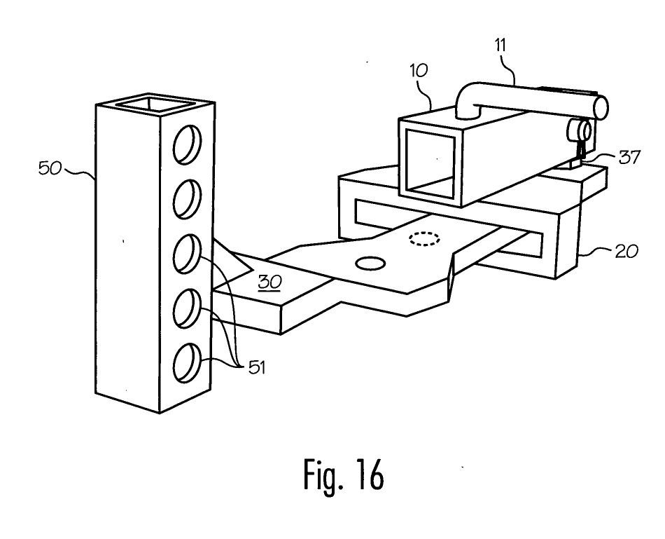

As a result, another embodiment of the present invention is shown in FIG. 16, this embodiment being adapted to be used with weight distribution hitch assemblies. In this embodiment, a weight distribution transfer member 50 is coupled to far tongue portion 34. Weight distribution transfer member 50 may generally be defined as a vertical, square shaped hollow structure having a plurality of weight distribution transfer holes 51 formed horizontally therethrough. Each of holes 51 is adapted to receive a conventional weight distribution hitch assembly (not shown, but known to those of skill in the art). Again, the operation of this embodiment is similar to the operation described above.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

Other variations and modifications of the present invention will be apparent to those of ordinary skill in the art, and it is the intent of the appended claims that such variations and modifications be covered. The particular values and configurations discussed above can be varied, are cited to illustrate representative embodiments of the present invention and are not intended to limit the scope of the invention. It is contemplated that the use of the present invention can involve components having different characteristics as long as the principle is followed.

We claim:

1. A height adjustable articulating tow hitch apparatus comprising
an upper housing unit adapted for coupling to a vehicle's receiver by a locking means,
an elongated tongue member having a near tongue portion disposed near the receiver, a middle tongue portion and a far tongue portion, the tongue member having one or more tongue holes formed therethrough along a longitudinal center path,
a lower housing unit attached to the upper housing unit, the lower housing unit having a near end near the receiver and a distal end further from the receiver, the lower housing unit having a hollow portion formed therethrough, the hollow portion having a generally tapered interior wall structure between a single pair of opposite interior walls, the hollow portion's horizontal width at the distal end defining a predetermined horizontal articulation angle, and
a lock and release mechanism extending through the upper housing, the lower housing, and engagable with any tongue hole to achieve a locked or unlocked position,
the tongue portion adapted to be slideably extendable, slideably retractable and slideably articulated within the lower housing's hollow portion, the tongue member's near tongue portion having a stop mechanism adapted to prevent the tongue member from being removed from the lower housing's hollow portion.

2. The apparatus of claim 1, the middle tongue portion adapted to provide a height differential adjustment between the near tongue portion relative to the far tongue portion.

3. The apparatus of claim 2 wherein the height differential adjustment between the near tongue portion relative to the far tongue portion is increasing.

4. The apparatus of claim 2 wherein the height differential adjustment between the near tongue portion relative to the far tongue portion is decreasing.

5. The appar'atus of claim 2 wherein the height differential adjustment between the near tongue portion relative to the far tongue portion is approximately equal.

6. The apparatus of claim 1, the tongue member's stop mechanism comprising a countersink assembly.

7. The apparatus of claim 2, the far tongue member having a hole formed therethrough at a generally center location defining a center hole, the far tongue hole approximately sized to receive a stem from a ball hitch assembly.

8. The apparatus of claim 7, the far tongue member further having at least two far tongue apertures formed therethrough at a general location adjacent to the center hole, the apparatus further comprising an anti-sway attachment means having opposite legs integrally formed with an upside-down U-shaped member therebetween, both legs having a leg hole formed therethrough, while U-shaped member has a member hole formed therethrough at a generally middle section, leg holes being positioned to vertically register with any the far tongue apertures, while member is formed to vertically register with the center hole.

9. The apparatus of claim 7, the far tongue member further comprising an attached weight distribution transfer member, the weight distribution transfer member defined as a vertical structure having a plurality of weight distribution transfer holes formed horizontally therethrough, each weight distribution transfer hole being adapted to receive a weight distribution hitch assembly.

10. A height adjustable articulating tow hitch assembly comprising
an upper housing unit adapted for coupling to a vehicle's receiver by a locking means,
a tongue member having a near tongue portion disposed near the receiver, a middle tongue portion and a far tongue portion, the tongue member having one hole formed therethrough along a longitudinal center path, the middle tongue portion adapted to provide a height differential adjustment between the near tongue portion relative to the far tongue portion,
a lower housing unit attached to the upper housing unit, the lower housing unit having a near end near the receiver and a distal end further from the receiver, the lower housing unit having a hollow portion formed therethrough, the hollow portion having a generally tapered interior wall structure between a single pair of opposite interior walls within the lower housing unit, the hollow portion's horizontal width at the distal end defining a predetermined horizontal articulation angle, and
a lock and release mechanism extending through the upper housing, the lower housing, and engagable with the tongue hole to achieve a biased or unbiased position,
the tongue portion adapted to be slideably extendable, slideably retractable and slideably articulated within the lower housing's hollow portion while remaining within the lower housing.

11. The apparatus of claim 10, the far tongue member having a hole formed therethrough at a generally center location defining a center hole, the far tongue hole approximately sized to receive a stem from a ball hitch assembly.

12. The apparatus of claim 10, the far tongue member further having at least two far tongue apertures formed therethrough at a general location adjacent to the center hole, the apparatus further comprising an anti-sway attachment means having opposite legs integrally formed with an upside-down U-shaped member therebetween, both legs having a leg hole formed therethrough, while U-shaped member has a member hole formed therethrough at a generally middle section, leg holes being positioned to vertically register with any the far tongue apertures, while member is formed to vertically register with the center hole.

13. The apparatus of claim 10, the far tongue member further comprising a weight distribution transfer member coupled to the far tongue member, the weight distribution transfer member defined as a vertical structure having a plurality of weight distribution transfer holes formed horizontally therethrough, each weight distribution transfer hole being adapted to receive a weight distribution hitch assembly.

14. A height adjustable articulating tow hitch assembly comprising
an upper housing unit adapted for coupling to a vehicle's receiver by a locking means,
a tongue member having a near tongue portion disposed near the receiver, a middle tongue portion and a far tongue portion, the near tongue portion having a stop mechanism, the far tongue member further having one hole formed therethrough along a longitudinal center path adapted to receive a stem from a ball hitch assembly, the tongue member having one or more tongue holes formed therethrough along a longitudinal center path, the middle tongue portion adapted to provide a height differential adjustment between the near tongue portion relative to the far tongue portion,
a lower housing unit coupled to the upper housing unit, the lower housing unit having a near end near the receiver and a distal end further from the receiver, the lower housing unit having a hollow portion formed therethrough, the hollow portion having a generally tapered interior wall structure between a single pair of opposite interior walls within the lower housing unit from the distal end and the near end, the other pair of interior walls within the lower housing unit not being tapered, the hollow portion's horizontal width at the distal end defining a predetermined horizontal articulation angle, and
a lock and release mechanism extending through the upper housing, the lower housing, and engagable with any of the tongue holes to achieve a biased or unbiased position,
wherein the stop mechanism is adapted to prevent the tongue member from being removed from the lower housing's hollow port while allowing longitudinal extension and retraction of the tongue member within the lower housing, and further, allowing angular movement of the tongue member when the tongue is in an extended position away from the upper housing, the tongue portion adapted to be slideably extendable, slideably retractable and slideably articulated within the lower housing's hollow portion while remaining within the lower housing.

15. The assembly of claim 14, the middle tongue portion adapted to provide a height differential adjustment between the near tongue portion relative to the far tongue portion.

16. The assembly of claim 15 wherein the height differential adjustment between the near tongue portion relative to the far tongue portion is increasing.

17. The assembly of claim 15 wherein the height differential adjustment between the near tongue portion relative to the far tongue portion is decreasing.

18. The assembly of claim 15 wherein the height differential adjustment between the near tongue portion relative to the far tongue portion is approximately equal.

19. The assembly of claim 15, the far tongue member further having at least two far tongue apertures formed therethrough at a general location adjacent to the center hole, the apparatus further comprising an anti-sway attachment means having opposite legs integrally formed with an upside-down U-shaped member therebetween, both legs having a leg hole formed therethrough, while U-shaped member has a member hole formed therethrough at a generally middle section, leg holes being positioned to vertically register with any the far tongue apertures, while member is formed to vertically register with the center hole.

20. The assembly of claim 15, the far tongue member further comprising a weight distribution transfer member coupled to the far tongue member, the weight distribution transfer member defined as a vertical structure having a plurality of weight distribution transfer holes formed horizontally therethrough, each weight distribution transfer hole being adapted to receive a weight distribution hitch assembly.
